(19) United States
(12) Patent Application Publication
(10) Pub. No.: US 2026/0147810 A1
(43) Pub. Date: May 28, 2026

(54) SYSTEMS AND METHODS FOR ENHANCED CONTEXT-AUGMENTED QUESTION RESPONSE SERVICES

(71) Applicant: Bold Limited, Hamilton (BM)

(72) Inventors: Victor SCHWARTZ, San Juan, PR (US); Brendan CAMPBELL, San Juan, PR (US); Allan FEITOSA, Sao Paulo (BR)

(21) Appl. No.: 18/962,528

(22) Filed: Nov. 27, 2024

(51) Int. Cl. G06F 16/334; G06F 16/22; G06Q 10/1053

(52) U.S. Cl. CPC G06F 16/3344; G06F 16/2237; G06Q 10/1053

(57) ABSTRACT

Certain aspects of the disclosure provide a method for generating context-augmented responses. In aspects, the method includes receiving a job application; extracting, from the job application, a question; generating, using an embedding model, a vector representation of the question; identifying, within a vector database, a most similar vector to the vector representation of the question; extracting, from a question-response database, an encoded context group; retrieving, from a job applicant database, professional context of the job applicant; generating, based on the context group and the professional context, a prompt chain for causing a language model to generate a response; processing, using the language model, the prompt chain to generate the response; calculating, using a risk scoring model, a risk score for the generated response; and in response to the risk score being below a predetermined threshold, populating a portion of the job application with the response.

### INTRODUCTION

### Technical Field

Aspects of the present disclosure relate to question-response systems.

### BACKGROUND

Question-response systems are designed for receiving, processing, and providing answers for user-submitted questions. While initial question-response systems relied on human operators, more recent implementations have increasingly incorporated virtual agents or expert systems for utilizing a knowledgebase of rules and domain-specific information for interpreting user queries and delivering responses. Question-response systems may be particularly useful in domains in which users are faced with high-volumes of diverse questions. For example, job applicants may be presented with a diverse set of questions for each job posting to which they apply. Improved techniques for implementing question-response systems for assisting job applicants would be desirable for promoting more effective and efficient response generation for job applications.

### SUMMARY

One aspect provides a method for generating context-augment responses, the method including: receiving a job application; extracting, from the job application, a question directed to a job applicant; generating, using an embedding model, a vector representation of the question; identifying, within a vector database, a most similar vector to the vector representation of the question, wherein the most similar vector is associated with an annotated historical question; extracting, from a question-response database, an encoded context group corresponding to the annotated historical question, wherein the encoded context group comprises a historical job applicant context and a job listing context; retrieving, from a job applicant database, professional context of the job applicant; generating, based on the context group and the professional context, a prompt chain for causing a language model to generate a response for the question directed to the job applicant; processing, using the language model, the prompt chain to generate the response; receiving, from the language model, the generated response for the question directed to the job applicant, wherein the generated response is based on the prompt chain; calculating, using a risk scoring model, a risk score for the generated response; and in response to the risk score being below a predetermined threshold, populating a portion of the job application with the generated response.

Another aspect provides a method for generating context-augmented responses, the method including: receiving a job application; extracting, from the job application, a question directed to a job applicant; generating, using an embedding model, a vector representation of the question; identifying, within a vector database, a most similar vector to the vector representation of the question, wherein the most similar vector is associated with an annotated historical question; extracting, from a question-response database, an encoded context group corresponding to the annotated historical question, wherein the encoded context group comprises a historical job applicant context and a job listing context; retrieving, from a job applicant database, professional context of the job applicant; generating, based on the context group and the professional context, a prompt chain for causing a language model to generate a response for the question directed to the job applicant; processing, using the language model, the prompt chain to generate the response; receiving, from the language model, the generated response for the question directed to the job applicant, wherein the generated response is based on the prompt chain; determining a category for the response; and in response to determining that the category for the response is associated with a predetermined list of categories, sending a feedback request to the job applicant.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an illustrative environment for implementing a question-response system according to one or more aspects shown and described herein.

FIG. 2 depicts an illustrative process implemented by a question-response system for extracting context for a given question according to one or more aspects.

FIG. 3 depicts an illustrative decision tree implemented by a question-response system for selecting a prompt template according to one or more aspects.

FIG. 4 depicts an illustrative process implemented by a question-response system for generating a response and corresponding output based on an illustrative auditing framework according to one or more aspects.

FIG. 5 depicts an illustrative job application that may be completed using a question-response system according to one or more aspects.

FIG. 6 depicts an illustrative user interface provided by a question-response system configured to employ an auditing framework to perform an illustrative process of requesting job applicant feedback according to one or more aspects.

FIG. 7 depicts an illustrative process implemented by a question-response system for storing user feedback according to one or more aspects.

FIG. 8 depicts an example method for generating context-augmented responses with a question-response system according to one or more aspects shown and described herein.

FIG. 9 depicts an example computing device for enabling a question-response system for generating context-augmented responses according to one or more aspects shown and described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating context-augmented responses for questions. For example, described aspects may generate responses for questions directed to a job applicant. Aspects described herein utilize multiple databases for extracting encoded context groups associated with annotated historical questions that are similar to a received question directed to a job applicant. Aspects described herein further utilize a job applicant database including professional context of a job applicant associated with a question. Aspects described herein utilize specially programmed processing device(s) to generate specialized prompts for processing by language models to assist in generating context-augmented responses based on the extracted encoded context groups and the professional context of the job applicant.

A language model is generally a type of machine learning model that is designed to understand, generate, and manipulate human language. More specifically, a language model is a probabilistic framework that determines the likelihood of a sequence of words or tokens. At its core, a language model attempts to predict the probability of the next word in a sentence given the preceding words. The model estimates these probabilities based on the patterns it learned during training. Language models are useful in natural language processing (NLP) and computational linguistics for performing a range of tasks involving human language.

Language models may be characterized by various components and capabilities. For example, a language model may include a vocabulary that defines the set of all possible words or tokens that the model can recognize and use. This includes common words, punctuation, and possibly domain-specific jargon. Language models may also consider a context, which refers to the preceding words in a sentence or sequence that the model uses to predict the next word. Modern language models often incorporate extensive context windows, leveraging entire sentences or even paragraphs.

Language model may be implemented in various ways. For example, N-gram models predict the next word based on the previous N−1 words. Neural network-based language models include Recurrent Neural Networks (RNNs), Long Short-Term Memory (LSTM) networks, and more Transformer models. These models capture more complex language patterns and context dependencies. The transformer architecture, introduced with models like BERT and GPT, utilizes self-attention mechanisms to handle long-range dependencies potentially more effectively than RNNs or LSTMs.

Language models are often trained using large corpora of text. The training process involves adjusting the model's parameters to minimize the difference between its predicted word probabilities and the actual word sequences in the training data. This is typically done via techniques like maximum likelihood estimation and gradient descent.

Language models have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

Thus, a language model is a sophisticated tool in NLP that analyzes and generates human language by understanding the probabilistic relationships between words and leveraging large datasets to learn these relationships. They form the backbone of many modern NLP applications, enabling machines to interpret, generate, and interact with human language.

Described aspects utilize language models for providing the features and benefits described above when generating responses for questions directed to a job applicant, thereby increasing the accuracy and precision of generated responses due to an increased amount of available context.

Aspects described herein further utilize a specialized auditing framework for requesting feedback from a job applicant for a generated response based on a calculated risk score, a category of the response, or a rule of a predetermined rule set, or a combination thereof.

Conventional job boards (e.g. applications, websites, platforms, etc.) lack streamlined processes for enabling a job applicant to easily apply to online job postings. Job applicants repeatedly answer similar questions across multiple job applications for different online job postings. For example, a job applicant may be asked to enter a response for a question regarding an expected compensation for multiple different job applications. This creates frustration and increases time investment on the part of the job applicant as they manually input redundant responses including the same information. Some conventional question-response systems of job boards attempt to solve this problem by storing and reusing historical job applicant responses for a specific question. However, questions within job applications may ask similar questions using different language or phrasing. For example, a question asking for the job applicant's name may appear as “First Name”, “Full Name”, or “Given Name.” Accordingly, conventional question-answer systems that simply map a historical job applicant response to a specific question are ineffective. This problem is further exacerbated for more complex job application questions, which may have increased numbers of permutations or question variations. Conventional techniques for identifying similar historical questions (e.g., using keyword matching by parsing and tokenizing stored questions to compare each word) for providing additional context is computationally expensive and takes significant time. Further, conventional question-response systems often used by job boards lack requisite intelligence for understanding complex questions associated with job applications due to a lack of context or historical data. This deficiency results in decreased accuracy when generating responses to a given question based on insufficient context for understanding the question itself, or insufficient context for generating a high quality response tailored to the job applicant.

In some examples, conventional question-response systems may use generic prompts for causing a large language model to answer a question directed to a job applicant. However, generic prompts may cause language models to generate low quality responses that are not tailored to the job applicant, that are prone to hallucinations, and/or that provide answers for sensitive or impactful questions that are risky to answer automatically without input from the job applicant. Generic prompts thus lead to responses having increased risk of negatively impacting a job applicant's chances of getting hired. Conventional question-response systems further lack sufficient means for mitigating downside risks (e.g. generating responses that are inaccurate, repetitive, lengthy, or have high risk of causing negative impact for the user) associated with generating responses with insufficient context, causing job applicants to bear the burden of ensuring that inaccurate or risky responses are not contained within a completed job application.

Aspects described herein provide a technical solution for the aforementioned technical problems by providing systems and methods for generating specialized prompt chains for causing a language model to generate context augmented responses to a question directed to a job applicant. In particular, aspects utilize the generated responses to automatically populate portions of a job application, thereby overcoming the constraints of conventional techniques that require job applicants to manually enter responses to questions. Aspects further utilize a vector database to identify, for a given question direct to a job applicant, a most similar annotated historical question for providing relevant context for generating a response. Described aspects may then extract and leverage an encoded context group for the annotated historical question to generate specialized prompt chains for causing a language model to generate an improved response to a question, thereby increasing accuracy and quality of generated responses as compared to conventional question-response systems.

Described aspects further employ an auditing framework for determining when user feedback should be requested for a given question or generated response. For example, described aspects may calculate risk scores for generated responses or categorize generated responses to trigger a feedback request to obtain approval or a written response directly from the job applicant. Thus, described aspects overcome the constraints of conventional question-response systems that are unable to mitigate risks (e.g. inaccurate answers, low-quality generic answers, high-risk answers, etc.) associated with generated answers that are derived from prompting a language model with a generic prompt that is not enriched with relevant context.

Described aspects for generating context-augmented responses for questions directed to a job applicant further provide for various technical benefits. As an example, described aspects utilize vector-based searches to identify a most similar vector corresponding to annotated historical question that is semantically similar to an extracted question directed to a job applicant. Vector-based searches performed by described aspects provide the technical benefit of improved speed and scalability in identifying semantically similar questions, even with large datasets. Described aspects may then utilize unique vector identifiers and metadata associated with the identified most similar vector to efficiently extract a relevant context group from a linked question-response database, thereby providing the technical benefit of reducing processing time and computation costs associated with conventional techniques for identifying similar historical questions and extracting associated context data. Described aspects further generate specialized prompts using context associated with an annotated historical question and professional context specific to the job applicant, thereby providing the technical benefit of improving accuracy of generated responses and further ensuring that the generated responses are relevant and tailored to the job applicant's specific background and experience. Described aspects further utilize an auditing framework for managing how different questions are handled to minimize excessive response generation and limit user feedback requests. In some examples, described aspects may provide historical responses for questions having an exact historical match. In other examples, described aspects may reuse responses provided by a user for a previously audited question. In yet other examples, described aspects may send a job applicant feedback request to obtain a written response from the job applicant. Thus, described aspects utilize the auditing framework to reduce unnecessary response generation, thereby providing the technical benefit of reducing computational costs associated with generating responses to extracted questions.

### Example Systems and Methods for Generating Context-Augmented Responses

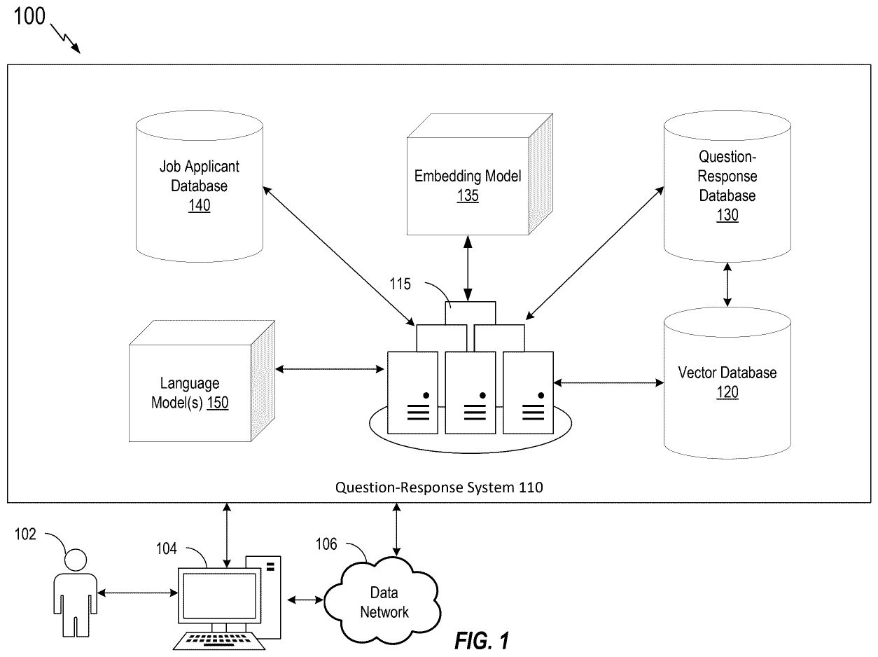

FIG. 1 depicts an illustrative environment 100 for implementing a question-response system according to one or more aspects shown and described herein.

In one example, the question-response system 110 may be an online job board (e.g. an application, a website, a platform, etc.) for enabling a user to automatically populate a job application for an online job posting hosted by the job board. As an example, question-response system 110 may be configured to extract questions from a job application for an online job posting, and then generate responses for populating the job application. The question-response system 110 may be configured to interface with a user 102 seeking to apply to an online job posting. User 102 may interface with aspects of question-response system 110, for example implemented by one or more computing devices, through a device 104. In certain aspects, device 104 may be a personal computer, a tablet computer, a smart device (e.g., a smartphone), or the like.

In certain aspects, device 104 includes a display device for implementing a user interface with the respective user 102, one or more processors for executing logic and one or more non-transitory computer-readable mediums for storing information and/or computer readable instructions. In certain aspects, device 104 operates as an interface for interacting with question-response system 110 via a suitable user interface (UI) provided by question-response system 110 via computing devices 115. Device 104 may access question-response system 110 via any suitable data network 106, such as the Internet. In certain aspects, question-response system 110 performs processes for generating context-augmented responses for questions directed to a job applicant using one or more computing devices 115. The one or more computing devices 115 (sometimes referred to as “processing systems”) of question-response system 110 may include one or more processors and one or more non-transitory computer-readable mediums storing computer readable instructions that, when executed by the one or more processors, cause the one or more computing devices to perform processes defined by computer-readable instructions corresponding to one or more components depicted and described herein.

Question-response system 110 includes a vector database 120. Vector database 120 stores and manages vectors (sometimes referred to as “embeddings”) for a set of historical questions and responses. As used herein, a “vector” may refer to a numerical array that captures the semantic meaning of a question or a response. A vector for a question or response may be generated using any suitable embedding model. Suitable embedding models may include, for example, a bidirectional encoder representations from transformers (BERT) model, or a neural network model for capturing semantic meaning. Each element of a given vector may include a numerical value representing a specific feature derived from text of a question or a response, such as contextual meaning, topics, or word relationships. The stored vectors within vector database 120 may include historical questions and responses handled by question-response system 110, or stored vectors associated with historical questions and responses of a same or similar domain from an alternative source.

Vector database 120 may be configured for storing high-dimensional vectors (e.g. having hundreds of dimensions) that include complex nuances and relationships within the encoded data. The vectors may be indexed and stored using any suitable techniques for promoting efficient vector similarity searches. Example techniques may include, but are not limited to, vector indexing with proximity graphs (e.g. using hierarchical navigable small world graphs), partitioning vector spaces with sharding, product quantization (PQ) or Scalar Quantization (SQ) for reducing memory footprint, pre-processing techniques for facilitating distance calculations, and metadata tagging for enabling more refined searches.

Question-response system 110 further includes a question-response database 130. Question-response database 130 store raw question-response data for the vector representations stored within vector database 120. Each vector of vector database 120 may include a unique numerical identifier for linking each vector to corresponding data stored within question-response database 130. In certain aspects, question-response database 130 may include any suitable database for storing question-response data in a flexible, non-relation format.

Question-response system 110 further includes an embedding model 135 for generating vector representations for a question directed to a job applicant. In certain aspects, embedding model 135 may include, a BERT model, or a neural network model for capturing semantic meaning of an extracted question (directed to a job applicant) from a given job application.

Question-response system 110 may generate vector representations for a given question, and then search vector database 120 for a most similar vector. Question-response system 110 may then utilize a unique vector identifier and metadata for a most similar vector to query question-response database 130 to extract context semantic data associated with an annotated historical question (and response) corresponding to the identified most similar vector.

In some aspects, extractable context groups may be manually annotated and stored in question-response database 130 for each annotated historical question. The context groups for each annotated historical question (and corresponding response) may include semantic data related to both job applicant context and job listing context. As used herein, “job applicant context” may include characteristics of a job applicant such as experience level, skills, industry, specializations, educational background, location preferences, language proficiencies, or other characteristics of a job applicant that may have contributed to generating (e.g., writing) a corresponding stored response to the annotated historical question. As used herein, “job listing context” may refer to characteristics of a listed job, such as a job title, job responsibilities, desired skills, experience expectations, industry, compensation ranges, or other characteristics of a listed job that may contribute to generating a corresponding stored response to an annotated historical question.

Question-response system 110 further includes a job applicant database 140. Job applicant database 140 may include “professional context” for job applicants using question-response system 110. As used herein, “professional context” may refer to any career-related information for a given job applicant that may be useful for answering a question of a job application that is directed towards the job applicant. Professional context for a given job applicant may include, but is not limited to, information related to skills, education, certifications, achievements, an industry, role, responsibilities, languages, tenure, awards, publications, affiliations, or any other information useful for answering questions of a job application. Job applicant database 140 may store data including professional context for a job applicant that is sourced from job applicant (e.g., user) registration or onboarding, job applicant resumes, and job applicant user profiles. In some examples, question-response system 110 includes a job board having a set of registered users (e.g., job applicants) who may use question-response system 110 to automatically populate questions of a job application. Job applicant database 140 may be used to store job applicant data gathered during a registration process. As an example, job applicant data stored during a registration process may include the job applicant's name, industry, years worked, geographic location, and other basic professional details. Job applicant database 140 may further store professional data for each job applicant including resume data or data from a user profile. In some examples, the resume data for a job applicant may include employment history, skills, qualifications, achievements, job titles, prior employers, employment dates, responsibilities, educational background, certifications and licenses, professional affiliates or memberships, and other professional data.

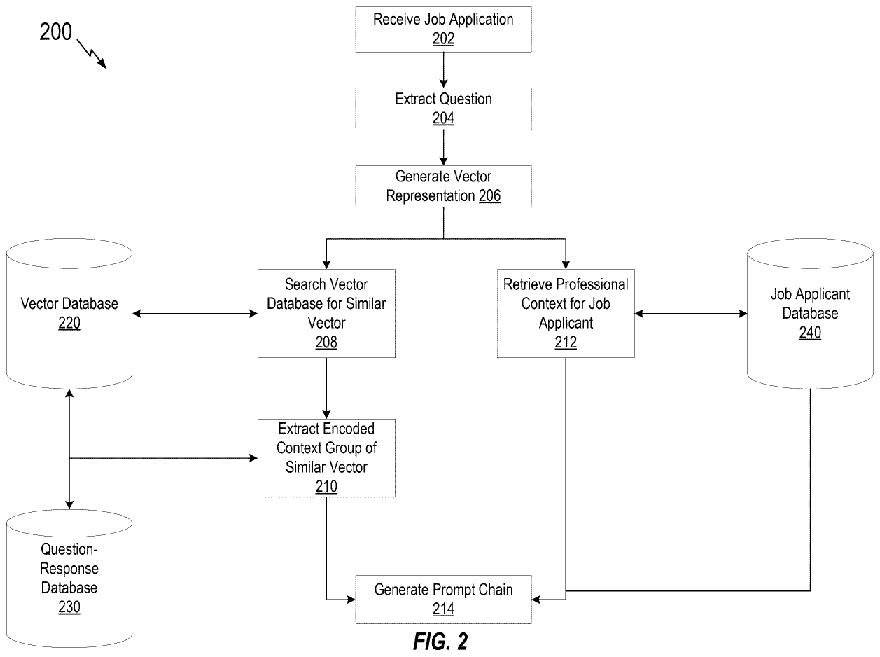

Described aspects may leverage the extracted context groups and the extracted professional context for the job applicant to augment generated responses for a given question directed to the job applicant. Illustrative processes performable by question-response system 110 to extract context for a given question are described in greater detail below with respect to process 200 of FIG. 2.

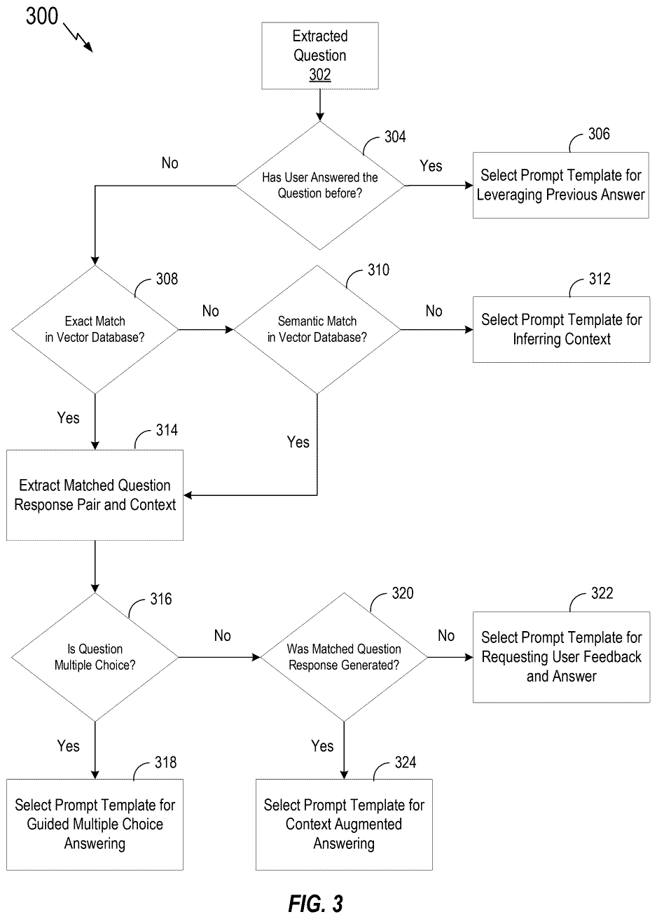

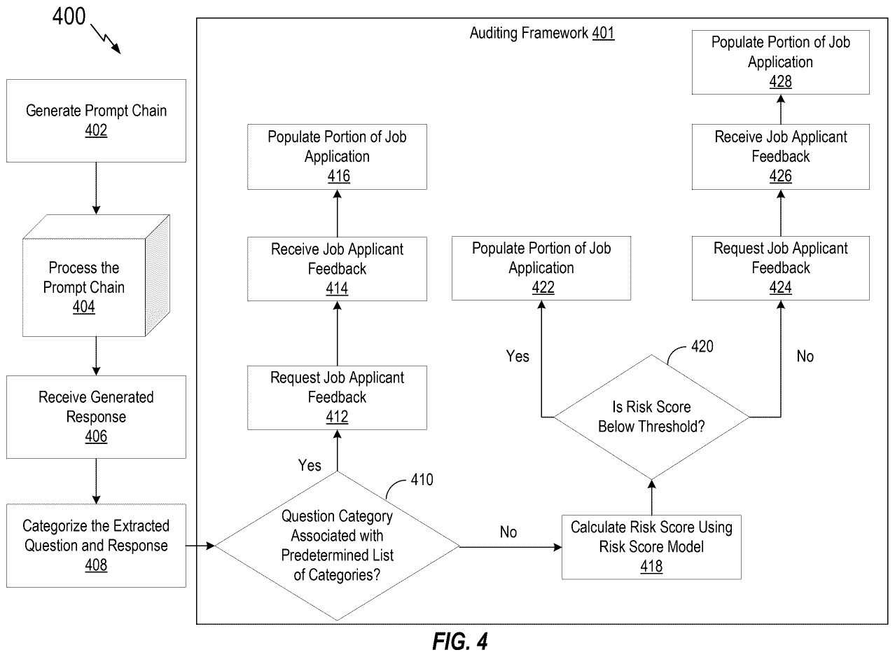

Question-response system 110 further includes language model(s) 150. Question-response system 110 utilize the extracted contexts described above to generate a specialized context-augmented prompt chain for causing the language model 150 to generate a response for a question directed to a job applicant. Processes for generating the specialized prompt chains to generate context-augmented responses are described in greater detail below with respect to FIGS. 3-4.

FIG. 2 depicts an illustrative process 200 implementable by an illustrative question-response system according to described aspects (such as question-response system 110 of FIG. 1) to extract context for a given question directed to a job applicant.

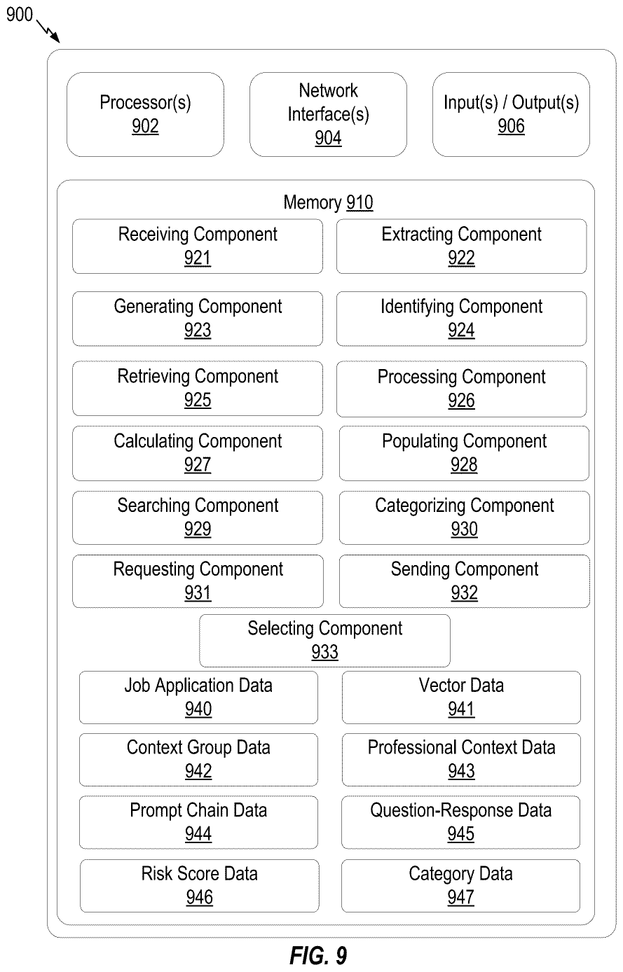

At 202, described aspects receive (for example, using receiving component 921 with reference to FIG. 9) a job application. As discussed, described aspects may include a job board having online job postings therein. A job applicant (such as user 102 with reference to FIG. 1) may request, via a suitable device operating as an interface for interacting with described aspects (such as device 104 with reference to FIG. 1), to apply to an online job posting associated with a given job application. As an example, a suitable user interface may allow a job applicant to interact with an icon to request to apply to an online job posting, causing a corresponding job application to be automatically sent to the question-response system.

At 204, described aspects extract (for example, using extracting component 922 with reference to FIG. 9) a question from the received job application. Described aspects may utilize any suitable natural language processing techniques to extract questions from a given job application. In some examples, described aspects may parse the job application to extract and convert the language of the job application into raw text, pre-process the raw text to perform tokenization and to remove extraneous words or symbols, and then utilize known natural language processing techniques for identifying individual questions. Described aspects may divide text of a job application into sentences using known open-source sentence segmentation tools such as SpaCY or NLTK. Described aspects may be configured to employ pre-trained models (such as BERT or other suitable pre-trained language models) that have been fine-tuned to classify questions for a specific domain (e.g. job boards) for classify sentences of the job application to identify questions. As an example, described aspects may extract a question from a job application stating “How many years of experience do you have as a project manager?”

At 206, described aspects generate (for example, using generating component 923 with reference to FIG. 9) a vector representation of the extracted question. Described aspects may utilize any suitable embedding model (such as embedding model 135 with reference to FIG. 1) to generate a vector representation of the extracted question. As discussed, each element of a given vector may include a numerical value representing a specific feature derived from text of the question, such as contextual meaning, topics, or word relationships.

At 208, described aspects search (for example, using searching component 929 with reference to FIG. 9) a vector database for a most similar vector. In some examples, described aspects search the vector database (such as vector database 120 with reference to FIG. 1) using similarity metrics (e.g. cosine similarity or Euclidean distance) to identify a most similar vector. As discussed, proper indexing and partitioning of stored high-dimensional vectors within the vector database facilitate efficient searches for identifying a most similar vector to the generated embedding corresponding to the extracted question. In certain aspects, the vector database may be configured to perform to search for the most similar vector based on semantic similarity. Once a most similar vector has been identified, described aspects may further receive a unique identifier (e.g. a numeric or alphanumeric string) and metadata for the most similar vector corresponding to the generated vector representation of the extracted question. The identified most similar vector corresponds to an annotated historical question having a corresponding historical response. Semantic data related to the annotated historical question and corresponding response may be stored within a question-response database (such as question-response database 130 with reference to FIG. 1) that is linked to the vector database.

Thus, rather than trying to query large datasets associated with individual questions and responses to identify similar historical questions, described aspects are configured to search vector databases (such as vector database 220) to identify a most similar vector for a vector representation of an extracted question. Described aspects utilize vector-based searching to provide the technical benefit of improved efficiency and scalability in extracting relevant context for a given extracted by enabling faster question and context retrieval more suitable for use with datasets that may be growing in size.

At 210, described aspects extract (for example, using extracting component 922 with reference to FIG. 9) an encoded context group of the most similar vector. The extracted encoded context group may include both job applicant context and job listing context for the annotated historical question corresponding to the most similar vector. Described aspects may extract the encoded context group by retrieving data from the question-response database 230 that is associated with the unique identifier and metadata for the most similar vector. Described aspects may further extract, from the question-response database, data including the exact question and response pair associated with the most similar vector. In some examples, described aspects may instead be configured to extract the context groups directly from metadata associated with an identified most similar vector.

As an example, described aspects may identify a most similar vector for a vector representation of an extracted question asking “How many years of experience do you have as a project manager?” Described aspects may determine that the annotated historical question corresponding to the most similar vector has a stored encoded context group including job applicant context associated with a job applicant having a job title of “senior project manager”, a location of “United States”, and experience of “12 years.” The encoded context group may further include job listing context including data indicating that the job listing for the annotated historical question was associated with a job title of “project manager,” a location of “United States,” and an experience expectation of “greater than 5 years.” Described aspects may then further extract data associated with the question and answer pair of the annotated historical question. For example, the question may have stated: “Have you worked for over 5 years as a project manager?” In the same example, the response for the annotated historical question may have stated “I have worked as a project manager for 12 years.”

Described aspects are thus able to extract, from encoded context groups, both job applicant context and job listing context for a given annotated historical question that is semantically similar to the extracted question of a given job application. Described aspects utilize the extracted context to better understand extracted questions, and to provide more comprehensive context during downstream generation of specialized prompt chains. Accordingly, described aspects utilize the specialized prompt chains for causing a language model to generate a response to the question, thereby providing the technical benefit of improved accuracy and quality in response generation due to having more comprehensive context that is closely related to the extracted question.

At 212, described aspects further extract (for example, using retrieving component 925 with reference to FIG. 9) professional context for the job applicant. The extracted professional context provides context for generating a response to an extracted question that is specifically tailored to professional characteristics of the job applicant using the question-response system. Described aspects extract professional context from a job applicant database (such as job applicant database 140 with reference to FIG. 1) that contains job applicant professional data. As discussed, the professional context may include data from the job applicant database that is derived from the user's professional resume, professional user profile, or questions answered during an onboarding or user registration process.

At 214, described aspects generate (for example, using generating component 923 with reference to FIG. 9) a prompt chain for causing a language model to generate a response to the extracted question directed to the job applicant. As used herein, a “prompt chain” refers to a set of prompts for guiding a language model to generate a response for a complex or multi-step task. In some examples, each prompt of the prompt chain may build on one or more previous sequential prompts to gradually narrow or refine the generated response to arrive at a more precise output. Well-designed prompt chains may improve accuracy and quality of responses, help to retain context, reduce errors and hallucinations, and help to customize or fine-tune the generated responses and final output from a language model. In some examples, described aspects utilize a locally-hosted language model. In certain examples, described aspects are instead configured to access the language model remotely via a suitable application programming interface (API) over an available data network (such as network interface 904 described below with reference to FIG. 9) or internet connection.

Described aspects are configured to select and utilize prompt templates for generating prompt chains specially designed for retaining and utilizing the extracted context (such as the job applicant context and job listing context from annotated historical questions and the professional context for a current job applicant) described above. Thus, described aspects further provide the technical benefit of improving the accuracy and quality of generated responses by selecting and utilizing prompt templates for causing a language model to generate a response having increased quality and accuracy, and that is specifically tailored to the job applicant based on extracted context from a most similar annotated historical questions as well as applicant-specific professional context.

In some examples, described aspects may select and utilize a prompt template for generating a prompt chain by navigating a decision tree. As used herein, a “prompt template” refers to a structured framework for generating dynamic prompt chains. The prompt template may include placeholders for variable information, enabling customization for each prompt of a prompt chain based on specific inputs. For example, an illustrative prompt template may include placeholders for features associated with extracted context associated with semantically similar annotated historical questions (such as the extracted context described above in connection with process 200 of FIG. 2). The prompt templates may further include placeholders for extracted professional job context associated with the job applicant to ensure the generated response is tailored to the job applicant. The prompt template may further include manually designed rules or instructions for managing formats, styles, tone, or other features of generated responses.

### Example Decision Tree for a Question-Response System

FIG. 3 depicts an illustrative decision tree 300 implemented by an illustrative question-response system for selecting a prompt template to generate a corresponding prompt chain according to one or more aspects. Described aspects may include a selecting component (for example, using selecting component 933 described below with reference to FIG. 9) configured to navigate a decision tree to select a prompt template that is tailored to an extracted question directed to a job applicant.

At 302, described aspects first consider a given extracted question to use as a root node for navigating decision tree 300. As an example, described aspects navigate the decision tree based on features or determinations in association with the extracted question.

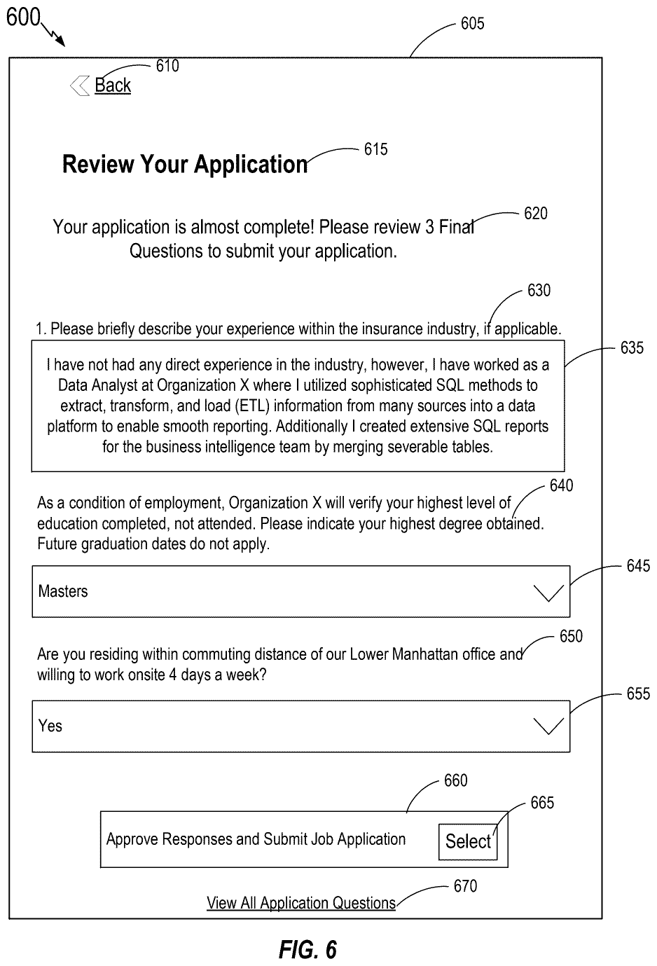

At 304, described aspects determine whether the user has answered the question before. As an example, described aspects may search a job applicant database (such as job applicant database 140 with reference to FIG. 1) to determine whether the job applicant (to whom the question is directed) has previously answered the question. In certain aspects, as described in greater detail below at FIG. 6, described aspects may be configured to receive and store user feedback, including previously answered questions, to facilitate determining whether a user has previously answered a given question.

At 306, in response to determining that the user has previously answered the question, described aspects select a prompt template for generating a corresponding prompt chain to cause a language model to leverage the previously used answer. In some examples, the selected prompt template is used to generate a prompt chain for causing the language model to simply reuse the previously used answer without generating additional content, thereby providing the technical benefit of reducing compute cost associated with generating a separate response including additional content. In another example, the selected prompt template is used to generate a corresponding prompt chain for causing the language model to modify or enhance the previously used answer. For example, described aspects may use the selected prompt template may to generate a prompt chain that includes the previously used answer, and further includes prompts and instructions for ensuring that the answer is concise, professional, and grammatically correct. In certain aspects, decision tree 300 may further include additional nodes for causing described aspects to select from one or more selectable prompt templates usable for generating different prompt chains for leveraging the previously used answer. For example, an additional node may cause described aspects to consider a corresponding risk score (for example, as described below in illustrative process 400 with reference to FIG. 4) associated with a previously used answer.

At 308, in response to determining that the user has not previously answered the extracted question, described aspects determine whether there is an exact match within the vector database of annotated historical questions and corresponding responses. For example, described aspects may use the techniques described above (such as in process 200 with reference to FIG. 2) to generate a vector representation of the described question, and search the vector database to determine whether there is an exact match stored within the vector database.

At 310, in response to determining that there is no exact match in the vector database, described aspects determine whether there is a semantic match in the vector database. For example, described aspects may use techniques, as described above (such as in process 200 with reference to FIG. 2) to determine whether a semantically similar match exists in the vector database. In some examples, described aspects are configured to determine whether a semantic match exists in the vector database based on a preconfigured similarity threshold.

At 312, in response to determining there is no semantic match in the vector database (e.g., no match that exceeds a similarity threshold), described aspects may select a prompt chain for inferring context. As an example, described aspects may select and utilize a prompt template that is designed to cause a language model to infer context in the absence of available context from historical questions. For example, the selected prompt template may include prompts for causing the language model to infer context for a provided question of a job application based on a list of potentially applicable context groups. The language model then generates a response based on the inferred context.

At 314, in response to determining that there is an exact match or a semantic match in the vector database, described aspects extract the matched question response pair and corresponding context (for example, as described above in process 200 with reference to FIG. 2).

At 316, described aspects determine if the question is multiple choice. A “multiple choice question” refers to a question directed to the job applicant which presents the job applicant with multiple different selectable answers. In some examples, the multiple choice question may ask the job applicant to select any number of applicable answers. In other examples, the multiple choice question may only be answered with a singular selected answer.

At 318, in response to determining that the question is a multiple choice question, described aspects select a prompt chain for guided multiple choice answering. For example, described aspects may select and utilize a prompt chain specifically designed for generating a corresponding prompt chain to cause a language model to answer a multiple choice question directed to the job applicant based on available context. In some examples, the generated prompt instructs the language model to select a singular most appropriate answer based on the language of the question. In other examples, the generated prompt instructs the language model to select multiple applicable answers based on the available context for the job applicant.

At 320, in response to determining the questions is not multiple choice, described aspects determine whether the matched response was generated. In other words, described aspects determine whether the matched response was generated by a language model, or manually written or input by a historical job applicant in the form of feedback.

At 322, in response to determining the matched response was not generated, described aspects select a prompt template for generating a corresponding prompt chain to cause a language model to generate a response requesting feedback from the user. As an example, if a matched response was based on user feedback, there is an increased chance that the question or the generated response is not suitable for being answered by a language model. Accordingly, described aspects may generate a prompt chain for causing the language model to generate a response requesting feedback from the user to ensure a portion of the job application is not populated with a risky or unsuitable generated response.

At 324, in response to determining the matched response was generated, described aspects select a prompt template for generating a corresponding prompt chain for causing a language model to generate a context-augmented response. For example, described aspects may select and utilize a prompt template for generating a prompt chain including extracted job applicant context and job listing context associated with an annotated historical answer that is semantically similar (or an exact match) to the extracted question. The generated prompt chain may further include professional context associated with the job applicant to ensure the generated response is tailored to the specific job applicant. Thus, described aspects intelligently select prompt templates to generate prompt chains including comprehensive extracted context for both the question and the job applicant, thereby providing the technical benefit of improving the accuracy and quality of generated responses.

FIG. 4 depicts an illustrative process implemented by a question-response system for generating a response and corresponding output based on an illustrative auditing framework according to one or more aspects.

At 402, described aspects generate (for example, using generating component 923 with reference to FIG. 9) a prompt chain. As discussed, the generated prompt chain may be based on a selected prompt template designed to include any extracted context associated annotated historical questions or professional context of the job applicant. The generated prompt chain may further include rules and instructions for managing the formats, styles, lengths, tone, and other features of the generated response.

At 404, a language model (such as language model 150 with reference to FIG. 1) processes (for example, using processing component 926 with reference to FIG. 9) the prompt chain to generate a context-augmented response to an extracted question directed to the job applicant.

At 406, described aspects receive (for example, using receiving component 921 with reference to FIG. 9), from the language model, the generated response.

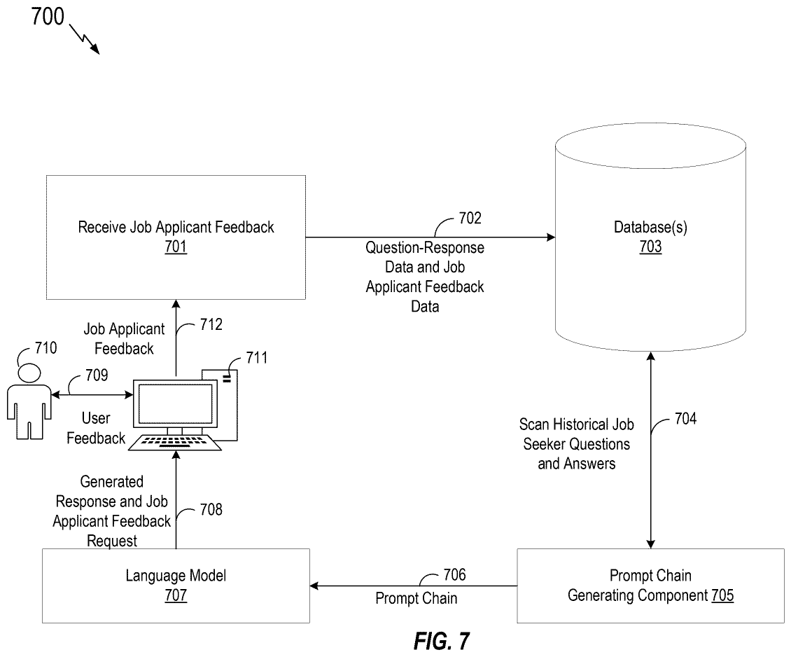

At 408, described aspects categorize (for example, using categorizing component 930 with reference to FIG. 9) to categorize the extracted question and the generated response. In some examples, described aspects may be configured to categorize the extracted question and generate response based on stored categories (for example, stored within in category data 947 with reference to FIG. 9) corresponding to a taxonomy for a domain associated with the annotated historical questions stored within the vector database. In some examples, described aspects may utilize a trained classifier neural network (for example, included within categorizing component 930 with reference to FIG. 9) which considers a predetermined list of categories and corresponding labeled examples (for example, stored in an accessible database, such as question-response database 130 described above with reference to FIG. 1) to classify an extracted question into one of the predetermined list of categories. In another example, common patterns (e.g. using sandbox testing) for different types of questions of a given domain may be logically grouped into a predetermined number of categories and stored within memory of a question-response system according to described aspects. In certain aspects, categories may be added and developed over time as additional patterns are identified as new questions are processed (such as using process 700 with reference to FIG. 7 to store feedback for downstream tasks). In other examples, described aspects may be configured to utilize known clustering algorithms (e.g. K-means or hierarchical clustering algorithms) to group new questions based on comparing distance in vector space between vector representations of the new questions and categorized vectors stored in the vector database. In yet another example, described aspects may utilize topic modeling techniques (e.g. Latent Dirichlet Allocation or non-negative matrix factorization to extract underlying topics from text of extracted questions to identify shared patterns within questions to define categories.

Described aspects may further include an auditing framework, such as illustrative auditing framework 401. Auditing framework 401 is used for determining and managing when a given question or generated response should be approved or manually written by a job applicant. Described aspects utilize an auditing framework to balance the interests in reducing time investment on the part of the job applicant (by generating responses to questions), while ensuring that the job applicant is sufficiently involved to maintain a sufficient standard for quality and truthfulness of generated answers. In certain aspects, the auditing framework may be employed as a logical decision tree.

At 410, described aspects determine whether a category for a generated response is associated with a predetermined list of categories. In some examples, described aspects may be configured to include a predetermined list of categories for determining whether a given question or response should trigger an audit by the job applicant. The predetermined list of categories may include hard-coded categories for questions or generated responses that will automatically trigger the question-response system to send a feedback request to the job applicant. The predetermined list of categories enables described aspects to maintain tighter controls over questions and responses having increased impact or risk, thereby minimizing downside risk on the part of the organization employing described aspects. In some examples, the predetermined list of categories may include descriptions of experiences (e.g. “Tell me about a time when . . . ”), demographic information (e.g. “What are your preferred pronouns?”), personal opinions (e.g. “What is your favorite management style”), and reasons for interest in a job (e.g. “Why are you interested in working at Company X”).

At 412, in response to determining that the question category is associated with the predetermined list of categories, described aspects may request job applicant feedback (for example, using requesting component 931 with reference to FIG. 9) from the job applicant. In some examples, described aspects may request feedback by prompting the use to provide approval or rejection of a generated response. In another example, described aspects may request feedback by prompting the individual to provide a written response for a given question.

At 414, described aspects may receive (for example, using receiving component 921 with reference to FIG. 9) job applicant feedback. In some examples, described aspects receive, from a job applicant, an approval or a rejection for a given generated response. In another example, described aspects receive a written response input by a job applicant in response to a request for job applicant feedback.

At 416, described aspects may populate (for example, using populating component 928 with reference to FIG. 9) a portion of a job application associated with the extracted question directed to the job applicant. In some examples, described aspects may populate the portion of the job application with a generated response that has been approved by the job applicant. In another example, described aspects may populate the portion of the job application with a received written response provided by the job applicant.

At 418, described aspects calculate (for example, using calculating component 927 with reference to FIG. 9) a risk score for a given extracted question or a corresponding generated response.

Described aspects utilize calculated risk scores as a part of an auditing framework, such as auditing framework 101, to further manage questions or generated responses having a calculated risk score above a predetermined threshold. In some aspects, the risk score is calculated by a risk scoring model that considers variables related to one or more of a length of the generated response, a difference between required context and available context for the question, a sensitivity value for an impact measurement associated with the question, a frequency value for the question, a hallucination risk score, and an originality score. For example, each of the above variables considered by the risk scoring model may be quantified on a standardized scale (e.g. 0 to 1, or 0 to 10) to be input into a function for calculating a risk score based on the variables. The risk score model may use the function for summing and normalizing individual risk values for each of the variables to calculate an aggregate score representing an overall risk for a generated response. In certain aspects, the function used by the risk model may further include a set of coefficients for determining how each of the variables are individually weighed when calculating the risk score. For example, an illustrative risk score function employable by the risk scoring model used by described aspects may be formulated as:

$$R = ( a \times L ) + ( b \times S ) + ( c \times H )$$

where “R” represents a risk score, “a”, “b”, and “c” represent respective coefficients for assigning a weight to each variable considered by the risk score model, “L” represents a length of a response (normalized to a value between 0 and 1), “S” represents a sensitivity value for an impact measurement associated with a question (normalized to a value between 0 and 1), and “H” represents a hallucination risk (normalized to a value between 0 and 1). Example variables considered by the risk model of described aspects are described in greater detail below.

Described aspects may consider a length of a generated response by measuring a number of characters or words within a generated response. In certain aspects, the calculated risk score may be increased based on the word count exceeding a length threshold (e.g. 50 words). In some examples, generated responses having increased lengths may be associated with higher risks of hallucinations by a language model, thereby decreasing accuracy and quality of generated responses.

In another example, described aspects may consider a measurable difference between required context and available context for a question. For example, an annotated historical question that is an exact match to an extracted question may indicate that 3 contextual features (e.g. a job title, years of experience, and location) are required for generating a response to an extracted question asking “How many years of experience do you have working as a project manager in North America?” Described aspects may then determine that the extracted professional context for the job applicant only includes a job title, but the years of experience and location of the job applicant are unavailable. Accordingly, sixty-six percent (two out of three features) of the required context is unavailable. Described aspects may then increase the calculated risk score by an amount representative of the measurable difference between required context and available context for the question.

Described aspects may further calculate a risk score based on a sensitivity value for an impact measurement associated with an extracted question. The sensitivity value may reflect a measure of how impactful it would be to generate a misleading or incorrect response for an extracted question. In certain aspects, the sensitivity value for an extracted question or a generated response may be associated with an annotated value for a category of the question or the response. For example, an extracted question related to a category for “demographic information” may be annotated with a numeric sensitivity value indicating that a misleading or incorrect response for the extracted question may have increased negative impact. Accordingly, described aspects may be configured to calculate a risk score based on a sensitivity value for an impact measurement associated with an extracted question.

Described aspects may further calculate a risk score based on a frequency value for the question. The frequency value may reflect a number of times a generated response has been used by a question-response system to populate a portion of a job application. While an increased frequency value may indicate importance, it may also be associated with an increased risk that the question-response system is repeating responses or overgeneralizing certain features. Described aspects may calculate the risk score based on the frequency value for a given generated response.

In certain aspects, the risk scoring model may further consider a hallucination risk score for a generated response. The hallucination risk score may include a numerical representation of a likelihood of generating information not based on factual data or training examples. The hallucination risk score may be based on past model behavior, or an extracted question's complexity. For example, if an extracted question is associated with one or more terms that fall outside of training data scope, or if prior responses to similar extracted questions deviated from known facts, the hallucination risk score for the generated response corresponding to that question may be higher than a different extracted question that is simpler. Furthermore, the hallucination risk score may increase for generated responses that involved a larger number of inferences made by the language model due to a lack of available context. Described aspects may utilize the risk scoring model to calculate a risk score based on the hallucination risk score for a generated response.

In some aspects, the risk scoring model may take into account additional features or variables as may be useful for calculating a risk score to determine whether to trigger an audit to request feedback from a job applicant for a given extracted question. The risk scoring model may further be configured to weigh considered features or variables differently as may be suitable for certain domains.

At 420, described aspects determine whether the calculated risk score is below a threshold. The threshold is used to determine whether to trigger an audit for a given extracted question or generated response.

At 422, in response to determining that the calculate risk score is below the threshold, described aspects populate (for example, using populating component 928 with reference to FIG. 9) a portion of a job application. The populated portion of the job application corresponds to a space on the application for answering the extracted question directed to the job applicant.

At 424, in response to determining that the calculated risk score is above the threshold, described aspects request (for example, using requesting component 931 with reference to FIG. 9) job applicant feedback. In some examples, the requested job applicant feedback may include a request for the job applicant to approve or reject a generated answer. In another example, the requested job applicant feedback may include a request for the job applicant to provide a written response to an extracted question having a calculated risk score that exceeds the threshold, indicating the risk to generate a response for that question is impermissibly high.

At 426, described aspects receive (for example, using receiving component 921 with reference to FIG. 9) job applicant feedback based on the requested job applicant feedback in a similar manner as described above at 414.

At 428, described aspects populate (for example, using populating component 928 with reference to FIG. 9) a portion of the job application. The populated portion of the job application at 428 is based on the received user feedback from 426. For example, if the received user feedback includes a written response from the job applicant, then the question-response system will populate the portion of the job application with the written response.

Accordingly, described aspects utilize auditing framework 401 to manage handling of different extracted questions to effectively balance the interests in reducing time investment on the part of the job applicant (by generating responses to questions), while ensuring that the job applicant is sufficiently involved to maintain a sufficient standard for quality and truthfulness of generated answers. In some examples, auditing framework 401 may cause described aspects to populate portions of a job application without generating a response based on historical responses (e.g. using historical responses for questions having an exact historical match, or using response to questions previously answered by a user), thereby providing the technical benefit of reducing computational costs by minimizing processing of unnecessary prompt chains. In other examples, the auditing framework employed by described aspects may utilize a calculated risk score (and a corresponding predetermined threshold) to determine when it is appropriate to request job applicant feedback to answer an extracted question, thereby further reducing computational costs by minimizing processing of unnecessary prompt chains.

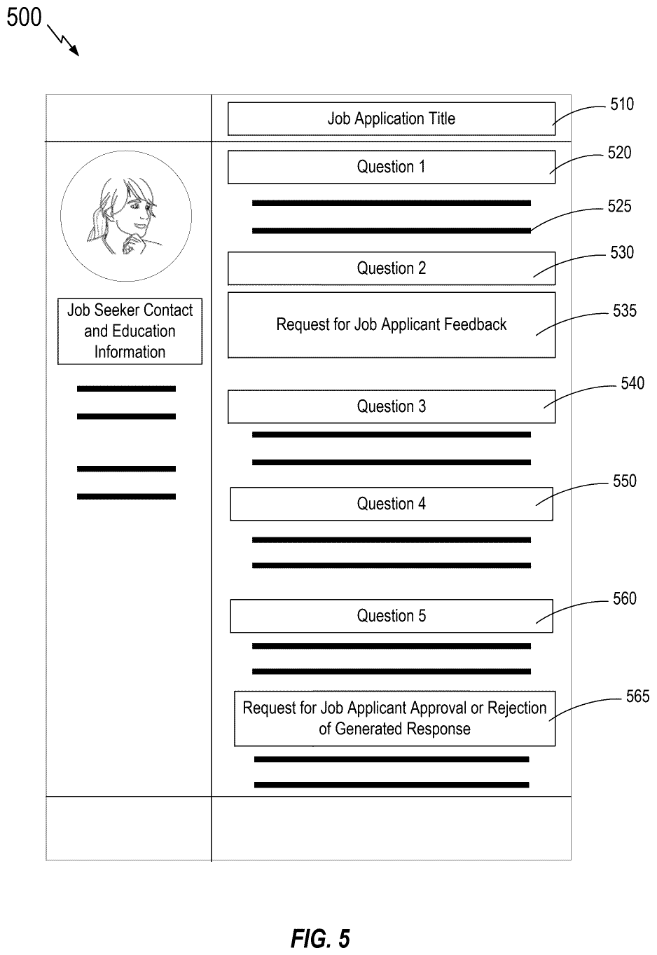

FIG. 5 depicts an illustrative job application 500 that may be completed using a question-response system according to one or more aspects. Job application 500 includes a job application title 510, and a set of questions 520, 530, 540, 550, and 560. As described above (for example, in illustrative processes 200 and 400 with reference to FIGS. 2 and 4), described aspects may extract each question and generate a prompt chain for causing a language model to generate a response for answering the extracted question. For example, described aspects generated a response 525 for question 520 (as well as questions 540 and 560), and populated a corresponding portion of job application 500 with the generated response.

At 535, described aspects request job applicant feedback for question 530 (“Question 2”). The requested job applicant feedback at 535 is not associated with a generated response, and instead requests a written response from the job applicant. The requested job applicant feedback at 535 may be based on question 520 being associated with a calculate risk score that exceeds a predetermined threshold, thereby causing described aspects to request a written response from the job applicant for populating the portion of the job application associated with question 520.

At 565, described aspects send, to the job applicant, a feedback request for approval or rejection of a generated response for question 560 (“Question 5”). Described aspects send the feedback request at 565 based on the calculated risk score for question 560 exceeding a predetermined threshold. In another example, described aspects send the feedback request based on question 560 having a determined category associated with a category of a predetermined list of categories that has been hard-coded to trigger an audit for the generated response.

FIG. 6 depicts an illustrative user interface 600 provided by a question-response system according to described aspects for performing an illustrative process of requesting job applicant feedback. User interface 600 shown in FIG. 6 is a graphical user interface (GUI), however in the context of the present disclosure, it is understood that the user interface 600 is not limited to a GUI, but rather may be implemented in other forms, such as spoken prompts, for example, which may be advantageous for users that are visually impaired. For brevity, the present disclosure will focus on a GUI version of the user interface 600. Described aspects may provide user interface 600 (or any other suitable user interface for interfacing with a job applicant) via employed computing devices or processing systems (such as computing devices 115 with reference to FIG. 1, or processing system 900 with reference to FIG. 9).

User interface 600 includes a first window 605 having a first selectable link 610 for enabling a job applicant to return to a previous screen. A title statement 615 prompts the user to review content for their automatically generated job application by following instructions 620. In certain aspects, user interface 600 may further include a second window for displaying a job posting associated with the job application in a side-by-side layout. For example, the second window may display the job title, the organization name, the location, the job description, and job requirements associated with the job posting.

User interface 600 further includes three questions 630, 640, and 650, each of which cause described aspects to request feedback from the job applicant (for example, based on illustrative process 400 described above with reference to FIG. 4). As an example, described aspects may be configured to request user feedback for a question having a category found within a predetermined list of categories that always trigger sending of a feedback request to the job applicant. Question 630 may belong to a category of questions in the predetermined list of categories that involve asking the job applicant to provide a response including personal and subjective experiences. Accordingly, described aspects may send a feedback request to prompt the job applicant to provide approval, or a written response to the question. User interface 600 further includes a response window 635 which enables a job applicant to view a generated response for question 630. Response window 635 may further enable the job applicant to manually input (e.g. by typing) and edit the content within response window 635.

As another example, described aspects may request job applicant feedback via user interface 600 for questions 640 and 650 based on calculating risk scores for corresponding generated responses that exceed a predetermined threshold (for example, as described above in illustrative process 400 with reference to FIG. 4). User interface 600 further includes a first drop down-menu 645 including a generated response for question 640, and a second drop-down menu 655 including a generated response for question 650. A job applicant may interact with drop-down menus 645 and 655 to modify the generated responses to questions 640 and 650, thereby providing feedback in the event that the generated response is not accepted by the job applicant.

User interface 600 further includes an icon 660 for approving the responses and submitting the job application. For example, the job applicant may approve the responses and submit the job application by interacting with a selectable icon 665. In certain aspects, the icon 660 may be selectable by the job applicant to approve the responses and submit the job application. In some examples, when the job applicant approves the responses and submits the application, data associated with the submitted job application, including the questions and corresponding responses may be sent to described question-response systems for storing as job applicant feedback. Illustrative processes for receiving and storing user feedback are described in greater detail below with reference to FIG. 7.

User interface 600 further include a selectable link 670 for enabling the user to view a list of all questions extracted from the job application. This enables the user to have the ability to view the entirety of the job application and the generated responses for optionally reviewing additional generated responses.

FIG. 7 depicts an illustrative process 700 implemented by a question-response system for storing user feedback according to one or more aspects. Described aspects leverage both historical questions and historical generated responses (for example, stored within vector database 120 and question-response database 130 with reference to FIG. 1) to enhance understanding of extracted questions, to gather more context, and to effectively utilize auditing frameworks for minimizing unnecessary response generation. Accordingly, illustrative process 700 serves as a continuous feedback loop for adding job applicant feedback associated with certain questions and generated responses to enhance available data for enhancing the above-described benefits.

At 701, described aspects receive (for example, using receiving component 921 with reference to FIG. 9) job applicant feedback. The job applicant feedback is provided to the question-response system, by the job applicant, in response to a request for job applicant feedback. In some examples, the job applicant feedback includes an approval or rejection of a generated answer for an extracted question directed to the job applicant. In other examples, the job applicant feedback includes a written response provided by the job applicant for an extracted question directed to the job applicant.

At 702, described aspects send (for example, using sending component 932 with reference to FIG. 9) the question-response data and the received job applicant feedback data to one or more databases 703. The question-response data may include the extracted question and the corresponding response (generated or written by the job applicant) with corresponding job applicant feedback data, such as approval or rejection of a generated response. The question-response data and job applicant feedback data is then stored within the one or more databases 703.

In certain aspects, the one or more databases 703 include a job applicant database (such as job applicant database 140 with reference to FIG. 1). In some examples, the one or more database 703 may further include a vector database (such as vector database 120 with reference to FIG. 1). Described aspects may further utilize an embedding model to generate a vector representation for the extracted question associated with the sent question-response data, and send the vector representation to the database 703 for storing. The stored question-response data and job applicant feedback data may be used to perform described processes (such as processes 200, and 400 described above with reference to FIGS. 2 and 4) of generating context-augmented responses for extracted questions directed to the job applicant.

At 704, described aspects scan historical job seeker questions and answers to better understand an extracted question and to extract relevant context from a most similar annotated historical question, for example, as described above in connection with process 200 with reference to FIG. 2.

At 705, a prompt chain generating component generates a prompt corresponding to a selected prompt chain as described above in connection with process 400 with reference to FIG. 4.

At 706, the prompt chain is sent to a language model 707 for processing the generated prompt chain to generate a context-augmented response for an extracted question as described above in connection with process 400 with reference to FIG. 4.

At 708, the generated response and a job applicant feedback request are sent to a device 611 configured to interface with described aspects for enabling a job applicant 710 to provide job applicant feedback in response to a job applicant feedback request. For example, described aspects may send the generated response and job applicant feedback request based on a calculated risk score for the generated response or the extracted question exceeding a predetermined threshold, as described above in connection with process 400 with reference to FIG. 4.

At 709, the job applicant 710 provides user feedback in response to the job applicant feedback request at 708, for example, using device 711.

At 712, the continuous loop is completed as the job applicant feedback is again received at 701 as described above. Accordingly, described aspects may continuously request job applicant feedback for sending and storing within one or more databases. The stored question-response data and job applicant feedback data further enhances the capabilities of described aspects to understand extracted questions and extract comprehensive context for generating an accurate and precise response. The stored job applicant feedback and question-response data are then utilized to generate additional responses and request additional job applicant feedback for further building the volume of available stored data using process 700.

### Example Method for Generating Context-Augmented Responses

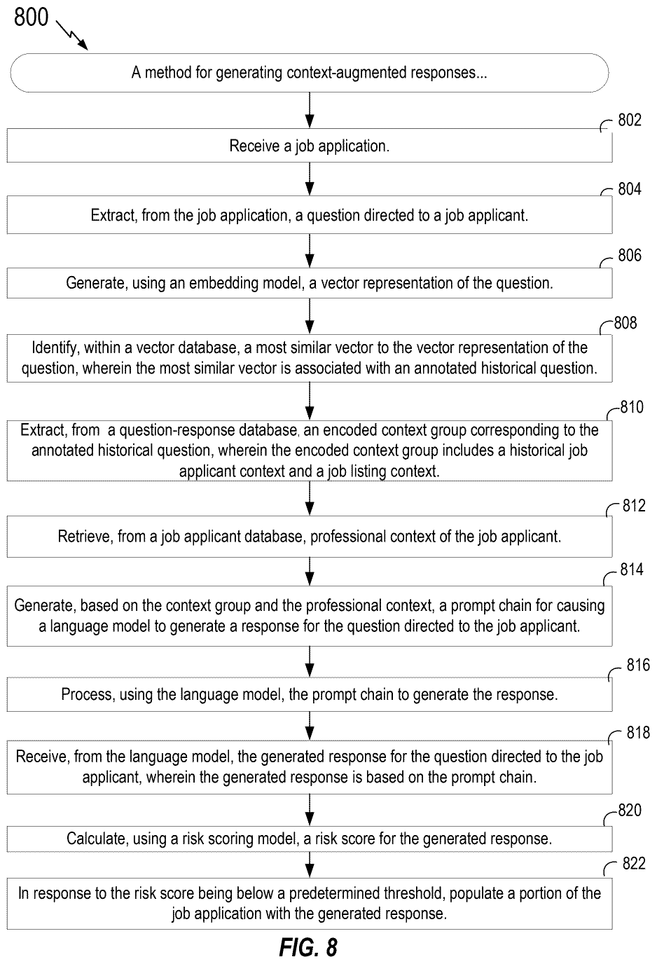

FIG. 8 depicts an example method 800 for generating context-augmented responses according to one or more aspects shown and described herein.

Method 800 begins at block 802 with receiving a job application. For example, block 802 may be performed by the one or more processing systems 900 described below with reference to FIG. 9, configured to implement components including, but not limited to, a receiving component 921.

Method 800 proceeds to block 804 with extracting, from the job application, a question directed to a job applicant. For example, block 804 may be performed by the one or more processing systems 900 described below with reference to FIG. 9, configured to implement components including, but not limited to, an extracting component 922.

Method 800 proceeds to block 806 with generating, using an embedding model, a vector representation of the question. For example, block 806 may be performed by the one or more processing systems 900 described below with reference to FIG. 9, configured to implement components including, but not limited to, a generating component 923.

Method 800 proceeds to block 808 with identifying, within a vector database, a most similar vector to the vector representation of the question, wherein the most similar vector is associated with an annotated historical question. For example, block 808 may be performed by the one or more processing systems 900 described below with reference to FIG. 9, configured to implement components including, but not limited to, an identifying component 924.

Method 800 proceeds to block 810 with extracting, from a question-response database. an encoded context group corresponding to the annotated historical question, wherein the encoded context group comprises a historical job applicant context and a job listing context. For example, block 810 may be performed by the one or more processing systems 900 described below with reference to FIG. 9, configured to implement components including, but not limited to, extracting component 922.

Method 800 proceeds to block 812 with retrieving, from a job applicant database, professional context of the job applicant. For example, block 812 may be performed by the one or more processing systems 900 described below with reference to FIG. 9, configured to implement components including, but not limited to, a retrieving component 925.

Method 800 proceeds to block 814 with generating, based on the context group and the professional context, a prompt chain for causing a language model to generate a response for the question directed to the job applicant. For example, block 814 may be performed by the one or more processing systems 900 described below with reference to FIG. 9, configured to implement components including, but not limited to, generating component 923.

Method 800 proceeds to block 816 with processing, using the language model, the prompt chain to generate the response. For example, block 816 may be performed by the one or more processing systems 900 described below with reference to FIG. 9, configured to implement components including, but not limited to, a processing component 926.

Method 800 proceeds to block 818 with receiving, from the language model, the generated response for the question directed to the job applicant, wherein the generated response is based on the prompt chain. For example, block 818 may be performed by the one or more processing systems 900 described below with reference to FIG. 9, configured to implement components including, but not limited to, receiving component 921.

Method 800 proceeds to block 820 with calculating, using a risk scoring model, a risk score for the generated response. For example, block 820 may be performed by the one or more processing systems 900 described below with reference to FIG. 9, configured to implement components including, but not limited to, a calculating component 927.

Method 800 proceeds to block 822 with, in response to the risk score being below a predetermined threshold, populating a portion of the job application with the generated response. For example, block 822 may be performed by the one or more processing systems 900 described below with reference to FIG. 9, configured to implement components including, but not limited to, populating component 928.

In some aspects, method 800 further includes in response to the risk score being above the predetermined threshold, requesting, from the job applicant, feedback for the generated response.

In some aspects, method 800 further includes receiving, from the job applicant, feedback for the generated response, and populating the portion of the job application based on the feedback. In certain aspects, the feedback for the generated response comprises a written response for answering the question directed to the job applicant.

In some aspects, method 800 further includes storing, within a user feedback database, question data corresponding to the question, user data corresponding to the job applicant, and feedback data corresponding to the feedback and the populated portion of the job application.

In some aspects, method 800 further includes selecting, based on navigation of a decision tree, a prompt template for generating the prompt chain, wherein the navigation of the decision tree is based on the question directed to the job applicant and corresponding historical data from the question-response database.

In some aspects, the risk score is based on one or more of a length of the generated response, a difference between required context and available context for the question, a sensitivity value for an impact measurement associated with the question, a frequency value for the question, and a hallucination risk score

Method 800 thus provides technical solutions to overcome shortcomings of conventional question-answer systems for generating responses to questions. Method 800 enables a question-response system to extract context groups from annotated historical questions that are most similar to an extracted question directed to a job applicant. The annotated historical question is identified by searching a vector database for a most similar vector, thereby providing the technical benefit of utilizing an efficient and quick search mechanism for identifying the annotated historical question for extracting context groups to promote understanding of the question and generation of responses having increased quality and accuracy. In aspects, method 800 further enables use of an auditing framework to manage handling of different extracted questions to effectively balance the interests in reducing time investment on the part of the job applicant (by generating responses to questions), while ensuring that the job applicant is sufficiently involved to maintain a sufficient standard for quality and truthfulness of generated answers. The auditing framework employed by described methods may utilize a calculated risk score (and a corresponding predetermined threshold) to determine when it is appropriate to request job applicant feedback to answer an extracted question, thereby providing the technical benefit of further reducing computational costs by minimizing processing of unnecessary prompt chains.

FIG. 8 is just one example of a method, and other methods including fewer, additional, or alternative steps are possible consistent with this disclosure.

### Example Processing System for Generating Context-Augmented Responses

FIG. 9 depicts an example processing system 900 upon which one or more aspects shown and described herein may be implemented.

The processing system 900 includes one or more processors 902. Generally, processor(s) 902 may be configured to execute computer-executable instructions (e.g., software code) to perform various functions, as described herein.

The processing system 900 further includes a network interface(s) 904, which generally provides data access to any sort of data network, including personal area networks (PANs), local area networks (LANs), wide area networks (WANs), the Internet, and the like.

The processing system 900 further includes input(s) and output(s) 906, which generally provide means for providing data to and from the processing system 900, such as via connection to computing device peripherals, including user interface peripherals.

The processing system 900 further includes a memory 910 configured to store various types of components and data.

In this example, memory 910 includes a receiving component 921, an extracting component 922, a generating component 923, an identifying component 924, a retrieving component 925, a processing component 926, a calculating component 927, a populating component 928, a searching component 929, a categorizing component 930, a requesting component 931, a sending component 932, and a selecting component 933.

Receiving component 921 may be configured to perform processes, for example, corresponding to blocks 802 and 818 of method 800 described above with reference to FIG. 8. Receiving component 921 may further be configured to perform processes, for example, corresponding to 202 of process 200 described above with reference to FIGS. 2, 406, 414, and 426 of process 400 described above with reference to FIG. 4, and 701 of process 700 described above with reference to FIG. 7.

Extracting component 922 may be configured to perform processes, for example, corresponding to blocks 804 and 810 of method 800 described above with reference to FIG. 8. Extracting component 922 may further be configured to perform processes, for example, corresponding to 204 and 210 of process 200 described above with reference to FIG. 2.

Generating component 923 may be configured to perform processes, for example, corresponding to blocks 806 and 814 of method 800 described above with reference to FIG. 8. Generating component 923 may further be configured to perform processes, for example, corresponding to 206 and 214 of process 200 described above with reference to FIG. 2, and 402 of process 400 described above with reference to FIG. 4.

Identifying component 924 may be configured to perform processes, for example, corresponding to block 808 of method 800 described above with reference to FIG. 8.

Retrieving component 925 may be configured to perform processes, for example, corresponding to block 812 of method 800 described above with reference to FIG. 8. Retrieving component 925 may further be configured to perform processes, for example, corresponding to 212 of process 200 described above with reference to FIG. 2.

Processing component 926 may be configured to perform processes, for example, corresponding to block 816 of method 800 described above with reference to FIG. 8. Processing component 926 may further be configured to perform processes, for example, corresponding to 404 of process 400 described above with reference to FIG. 4.

Calculating component 927 may be configured to perform processes, for example, corresponding to block 820 of method 800 described above with reference to FIG. 8. Calculating component 927 may further be configured to perform processes, for example, corresponding to 418 of process 400 described above with reference to FIG. 4.

Populating component 928 may be configured to perform processes, for example, corresponding to block 822 of method 800 described above with reference to FIG. 8. Populating component 928 may further be configured to perform processes, for example, corresponding to 416, 422, and 428 of process 400 described above with reference to FIG. 4.

Searching component 929 may be configured to perform processes, for example, corresponding to 208 of process 200 described above with reference to FIG. 2.

Categorizing component 930 may be configured to perform processes, for example, corresponding to 408 of process 400 described above with reference to FIG. 4.

Requesting component 931 may be configured to perform processes, for example, corresponding to 424 of process 400 described above with reference to FIG. 4.

Sending component 932 may be configured to perform processes, for example, corresponding to 702 of process 700 described above with reference to FIG. 7.

Selecting component 933 may be configured to perform processes, for example, corresponding to 304-324 for navigating illustrative decision tree 300 with reference to FIG. 3.

In this example, memory 910 also includes job application data 940, vector data 941, context group data 942 (for example, including job applicant context and job listing context for annotated historical questions), professional context data 943, prompt chain data 944, question-response data 945, risk score data 946, and category data 947.

The processing system 900 may be implemented in various ways. For example, the processing system 900 may be implemented within on-site, remote, or cloud-based computing devices.

The processing system 900 is just one example, and other configurations are possible. For example, in alternative aspects, aspects described with respect to the processing system 900 may be omitted, added, or substituted for alternative aspects.

### Example Clauses

Implementation examples are described in the following numbered clauses:

Clause 1: A method for generating context-augmented responses includes receiving a job application; extracting, from the job application, a question directed to a job applicant; generating, using an embedding model, a vector representation of the question; identifying, within a vector database, a most similar vector to the vector representation of the question, wherein the most similar vector is associated with an annotated historical question; extracting, from a question-response database, an encoded context group corresponding to the annotated historical question, wherein the encoded context group comprises a historical job applicant context and a job listing context; retrieving, from a job applicant database, professional context of the job applicant; generating, based on the context group and the professional context, a prompt chain for causing a language model to generate a response for the question directed to the job applicant; processing, using the language model, the prompt chain to generate the response; receiving, from the language model, the generated response for the question directed to the job applicant, wherein the generated response is based on the prompt chain; calculating, using a risk scoring model, a risk score for the generated response; and in response to the risk score being below a predetermined threshold, populating a portion of the job application with the generated response.

Clause 2: The method of Clause 1, further comprising: in response to the risk score being above the predetermined threshold, requesting, from the job applicant, feedback for the generated response.

Clause 3: The method of Clause 2, further comprising receiving, from the job applicant, feedback for the generated response; and populating the portion of the job application based on the feedback.

Clause 4: The method of any one of Clauses 1-3, further comprising storing, within a user feedback database, question data corresponding to the question, user data corresponding to the job applicant, and feedback data corresponding to the feedback and the populated portion of the job application.

Clause 5: The method of any one of Clauses 1-4, wherein the feedback for the generated response comprises a written response for answering the question directed to the job applicant.

Clause 6: The method of any one of Clauses 1-5, wherein generating, based on the context group and the professional context, the prompt chain for causing the language model to generate the response for the question directed to the job applicant further comprises selecting, based on navigation of a decision tree, a prompt template for generating the prompt chain, wherein the navigation of the decision tree is based on the question directed to the job applicant and corresponding historical data from the question-response database.

Clause 7: The method of any one of Clauses 1-6, wherein the risk score is based on one or more of a length of the generated response, a difference between required context and available context for the question, a sensitivity value for an impact measurement associated with the question, a frequency value for the question, and a hallucination risk score.

Clause 8: A method for generating context-augmented responses includes receiving a job application; extracting, from the job application, a question directed to a job applicant; generating, using an embedding model, a vector representation of the question; identifying, within a vector database, a most similar vector to the vector representation of the question, wherein the most similar vector is associated with an annotated historical question; extracting, from a question-response database, an encoded context group corresponding to the annotated historical question, wherein the encoded context group comprises a historical job applicant context and a job listing context; retrieving, from a job applicant database, professional context of the job applicant; generating, based on the context group and the professional context, a prompt chain for causing a language model to generate a response for the question directed to the job applicant; processing, using the language model, the prompt chain to generate the response; receiving, from the language model, the generated response for the question directed to the job applicant, wherein the generated response is based on the prompt chain; determining a category for the response; and in response to determining that the category for the response is associated with a predetermined list of categories, sending a feedback request to the job applicant.

Clause 9: The method of Clause 8, further comprising receiving, from the job applicant, feedback for the generated response; and populating a portion of the job application based on the feedback.

Clause 10: The method of Clause 9, wherein the feedback for the generated response comprises a written response for answering the question directed to the job applicant.

Clause 11: The method of any one of Clauses 8-10, wherein generating, based on the context group and the professional context, the prompt chain for causing the language model to generate the response for the question directed to the job applicant further comprises: selecting, based on navigation of a decision tree, a prompt template for generating the prompt chain, wherein the navigation of the decision tree is based on the question directed to the job applicant and corresponding historical data from the question-response database.

Clause 12: The method of any one of Clauses 8-11, wherein determining the category for the response further comprises: determining, using a trained classifier neural network, a question category for the question based on the predetermined list of categories and corresponding labeled examples; and determining the category for the response based on the question category.

Clause 13: The method of any one of Clauses 8-12, further comprising storing, within a user feedback database, question data corresponding to the question, user data corresponding to the job applicant, and feedback data corresponding to the feedback and the populated portion of the job application.

Clause 14: A processing system, comprising means for performing a method in accordance with any one of Clauses 1-13.

Clause 15: A non-transitory computer-readable medium comprising computer-executable instructions that, when executed by one or more processors of a processing system, cause the processing system to perform a method in accordance with any one of Clauses 1-13.

Clause 16: A computer program product embodied on a computer-readable storage medium comprising code for performing a method in accordance with any one of Clauses 1-13.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating context-augmented responses, the method comprising:
receiving a job application;
extracting, from the job application, a question directed to a job applicant;
generating, using an embedding model, a vector representation of the question;
identifying, within a vector database, a most similar vector to the vector representation of the question, wherein the most similar vector is associated with an annotated historical question;
extracting, from a question-response database, an encoded context group corresponding to the annotated historical question, wherein the encoded context group comprises a historical job applicant context and a job listing context;
retrieving, from a job applicant database, professional context of the job applicant;
generating, based on the context group and the professional context, a prompt chain for causing a language model to generate a response for the question directed to the job applicant;
processing, using the language model, the prompt chain to generate the response;
receiving, from the language model, the generated response for the question directed to the job applicant, wherein the generated response is based on the prompt chain;
calculating, using a risk scoring model, a risk score for the generated response; and
in response to the risk score being below a predetermined threshold, populating a portion of the job application with the generated response.

2. The method of claim 1, further comprising: in response to the risk score being above the predetermined threshold, requesting, from the job applicant, feedback for the generated response.

3. The method of claim 2, further comprising:
receiving, from the job applicant, feedback for the generated response; and
populating the portion of the job application based on the feedback.

4. The method of claim 3, further comprising storing, within a user feedback database, question data corresponding to the question, user data corresponding to the job applicant, and feedback data corresponding to the feedback and the populated portion of the job application.

5. The method of claim 3, wherein the feedback for the generated response comprises a written response for answering the question directed to the job applicant.

6. The method of claim 1, wherein generating, based on the context group and the professional context, the prompt chain for causing the language model to generate the response for the question directed to the job applicant further comprises:
selecting, based on navigation of a decision tree, a prompt template for generating the prompt chain,
wherein the navigation of the decision tree is based on the question directed to the job applicant and corresponding historical data from the question-response database.

7. The method of claim 1, wherein the risk score is based on one or more of a length of the generated response, a difference between required context and available context for the question, a sensitivity value for an impact measurement associated with the question, a frequency value for the question, and a hallucination risk score.

8. A processing system, comprising:
one or more memories comprising computer-executable instructions; and
one or more processors configured to execute the computer-executable instructions causing the processing system to:
receive a job application;
extract, from the job application, a question directed to a job applicant;
generate, using an embedding model, a vector representation of the question;
identify, within a vector database, a most similar vector to the vector representation of the question, wherein the most similar vector is associated with an annotated historical question;
extract, from a question-response database, an encoded context group corresponding to the annotated historical question, wherein the encoded context group comprises a historical job applicant context and a job listing context;
retrieve, from a job applicant database, professional context of the job applicant;
generate, based on the context group and the professional context, a prompt chain for causing a language model to generate a response for the question directed to the job applicant;
process, using the language model, the prompt chain to generate the response;
receive, from the language model, the generated response for the question directed to the job applicant, wherein the generated response is based on the prompt chain;
calculate, using a risk scoring model, a risk score for the generated response; and
in response to the risk score being below a predetermined threshold, populate a portion of the job application with the generated response.

9. The processing system of claim 8, wherein the one or more processors are further configured to cause the processing system to, in response to the risk score being above the predetermined threshold, request, from the job applicant, feedback for the generated response.

10. The processing system of claim 8, wherein the one or more processors are further configured to cause the processing system to:
receive, from the job applicant, feedback for the generated response; and
populate the portion of the job application based on the feedback.

11. The processing system of claim 8, wherein the one or more processors are further configured to cause the processing system to store, within a user feedback database, question data corresponding to the question, user data corresponding to the job applicant, and feedback data corresponding to the feedback and the populated portion of the job application.

12. The processing system of claim 10, wherein the feedback for the generated response comprises a written response for answering the question directed to the job applicant.

13. The processing system of claim 8, wherein to generate, based on the context group and the professional context, the prompt chain for causing the language model to generate the response for the question directed to the job applicant, the one or more processors are further configured to cause the processing system to:
select, based on navigation of a decision tree, a prompt template for generating the prompt chain,
wherein the navigation of the decision tree is based on the question directed to the job applicant and corresponding historical data from the question-response database.

14. The processing system of claim 8, wherein the risk score is based on one or more of a length of the generated response, a difference between required context and available context for the question, a sensitivity value for an impact measurement associated with the question, a frequency value for the question, a hallucination risk score.

15. A method for generating context-augmented responses, the method comprising:
receiving a job application;
extracting, from the job application, a question directed to a job applicant;
generating, using an embedding model, a vector representation of the question;
identifying, within a vector database, a most similar vector to the vector representation of the question, wherein the most similar vector is associated with an annotated historical question;
extracting, from a question-response database, an encoded context group corresponding to the annotated historical question, wherein the encoded context group comprises a historical job applicant context and a job listing context;
retrieving, from a job applicant database, professional context of the job applicant;
generating, based on the context group and the professional context, a prompt chain for causing a language model to generate a response for the question directed to the job applicant;
processing, using the language model, the prompt chain to generate the response;
receiving, from the language model, the generated response for the question directed to the job applicant, wherein the generated response is based on the prompt chain;
determining a category for the response; and
in response to determining that the category for the response is associated with a predetermined list of categories, sending a feedback request to the job applicant.

16. The method of claim 15, further comprising:
receiving, from the job applicant, feedback for the generated response; and
populating a portion of the job application based on the feedback.

17. The method of claim 16, wherein the feedback for the generated response comprises a written response for answering the question directed to the job applicant.

18. The method of claim 15, wherein generating, based on the context group and the professional context, the prompt chain for causing the language model to generate the response for the question directed to the job applicant further comprises:
selecting, based on navigation of a decision tree, a prompt template for generating the prompt chain,
wherein the navigation of the decision tree is based on the question directed to the job applicant and corresponding historical data from the question-response database.

19. The method of claim 15, wherein determining the category for the response further comprises:
determining, using a trained classifier neural network, a question category for the question based on the predetermined list of categories and corresponding labeled examples; and
determining the category for the response based on the question category.

20. The method of claim 16, further comprising storing, within a user feedback database, question data corresponding to the question, user data corresponding to the job applicant, and feedback data corresponding to the feedback and the populated portion of the job application.
